(19) United States
(12) Patent Application Publication
(10) Pub. No.: US 2018/0354443 A1
(43) Pub. Date: Dec. 13, 2018

(54) System and Method for Child Car Seat Safety Detection and Notification

(71) Applicants: Nona Ebrahimi, Chandler, AZ (US); Joseph M. Romeo, Chandler, AZ (US); Christopher L. Ross, Phoenix, AZ (US); Rene J. Sanchez, Chandler, AZ (US); Marcie M. Miller, Chandler, AZ (US); Jill C. Sciarappo, Chandler, AZ (US); Amarnath Kona, Dublin, CA (US); Shubhada H. Sahasrabudhe, Gilbert, AZ (US); Matthew J. Schneider, Chandler, AZ (US); Rod E. Kronschnabel, Chandler, AZ (US); Thomas V. Moss, Chandler, AZ (US); Steven Whitehorn, Gilbert, AZ (US); Kevin Edwards, Maricopa, AZ (US); Keith A. Swesey, Prescott, AZ (US); Cecilia Yancy, Gilbert, AZ (US); Camilo F. Gomez, Albuquerque, NM (US)

(72) Inventors: Nona Ebrahimi, Chandler, AZ (US); Joseph M. Romeo, Chandler, AZ (US); Christopher L. Ross, Phoenix, AZ (US); Rene J. Sanchez, Chandler, AZ (US); Marcie M. Miller, Chandler, AZ (US); Jill C. Sciarappo, Chandler, AZ (US); Amarnath Kona, Dublin, CA (US); Shubhada H. Sahasrabudhe, Gilbert, AZ (US); Matthew J. Schneider, Chandler, AZ (US); Rod E. Kronschnabel, Chandler, AZ (US); Thomas V. Moss, Chandler, AZ (US); Steven Whitehorn, Gilbert, AZ (US); Kevin Edwards, Maricopa, AZ (US); Keith A. Swesey, Prescott, AZ (US); Cecilia Yancy, Gilbert, AZ (US); Camilo F. Gomez, Albuquerque, NM (US)

(21) Appl. No.: 15/776,017

(22) PCT Filed: Dec. 18, 2015
(86) PCT No.: PCT/US2015/066634

§ 371 Date: May 14, 2018

(51) Int. Cl. B60R 21/015; B60R 22/10; B60N 2/26; G08B 21/02

(52) U.S. Cl. CPC B60R 21/01556; G08B 21/0277; B60N 2/26; B60R 22/105

(57) ABSTRACT

A system and method for child car seat safety detection and notification are disclosed. A particular embodiment is configured to: provide at least one sensor to measure a condition present in an environment in which a child is restrained in a child car seat in a vehicle; determine, based on sensor data from the sensor, if the condition requires a notification to be sent to a user; generate a notification message including at least a portion of the sensor data and information indicative of a location of the child car seat; send the notification message to a mobile device application; and send the notification message to a vehicle subsystem application.

### TECHNICAL FIELD

This patent application relates to electronic systems, mobile devices, wireless devices, vehicle passenger seating, child car seats, and computer-implemented software, according to various example embodiments, and more specifically to a system and method for child car seat safety detection and notification.

### BACKGROUND

Child safety continues to pose a major concern in all commercial industries, particularly the automotive sector where safety is a key differentiator. Car seat design has undoubtedly saved countless lives in vehicle collisions. However, child death can also occur as a result of hyperthermia, heat stroke, dehydration and other heat related illnesses resulting from a child being left unattended in motor vehicles in their car seats. Typically, this occurs as a result of the caregiver simply forgetting the child is in the car and then inadvertently locking the child within the car. This is especially problematic with infants and toddlers, as they are often left restrained in a car seat (while the internal temperature of the vehicle increases due to hot weather conditions or at the other extreme, reduces to a severely low temperature). Additionally, children in car seats can be a distraction to the driver while the vehicle is in motion. Existing systems have been unable to address both the problems of unattended children and driver distraction in regard to child car seat design.

### BRIEF DESCRIPTION OF THE DRAWINGS

The various embodiments are illustrated by way of example, and not by way of limitation, in the figures of the accompanying drawings in which:

FIGS. 1 and 2 illustrate how a conventional child seat buckle mechanism can be latched in an example embodiment;

FIG. 3 illustrates another example embodiment of the child seat monitoring system integrated into a single-side clip-on device that can be attached to a portion of the child seat restraints of a typical child seat;

FIG. 4 illustrates other example embodiments of various types of child seats with one or more portions of the child seat monitoring system integrated into various portions of the child seat;

FIG. 5 illustrates an embodiment of an ecosystem in which embodiments of the child seat monitoring system can operate;

FIG. 6 illustrates an example embodiment in which a mobile device application can receive sensor data from the child seat monitoring system and produce an information or notification page on a mobile device user interface;

FIG. 7 is a processing flow chart illustrating an example embodiment of a method as described herein; and

FIG. 8 shows a diagrammatic representation of a machine in the example form of a mobile computing and/or communication system within which a set of instructions when executed and/or processing logic when activated may cause the machine to perform any one or more of the methodologies described and/or claimed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In the various embodiments described herein, a system and method for child car seat safety detection and notification are disclosed. Example embodiments are described wherein a car seat system monitors children seated in a child car seat and the child's environment, so the child's guardian can determine exactly what is going on in the child's environment. Using sensors and output devices integrated into the child's car seat or clipped to the car seat, the driver or other guardian can see, talk to, play music for, and understand the child's environment, all from the front seat of the vehicle through the car's In-Vehicle Infotainment (IVI) system or via the guardian's mobile device/smartphone. In addition, the various embodiments described herein can communicate with parties outside of the vehicle to report the current status of the child's environment or in case of an emergency. As such, the various embodiments can monitor and modify the child's environment from a place internal or external to the vehicle in which the child is located.

An example embodiment can be used with or implemented as an Internet of Things (IoT) type of device to connect any user device to the child car seat and the child therein. The various embodiments described herein can use any device (e.g., a smartphone, the vehicle IVI system, a tablet device, or the like) to wirelessly communicate with a child seat monitoring system integrated into or clipped to a child car seat. The various embodiments described herein can operate in response to explicit user actions or automatically/autonomously in response to conditions or events detected in the child's environment.

As described in more detail below, the various embodiments disclosed herein integrate a number of sensors and output devices into and surrounding the child car seat. As a result, data related to the child's wellbeing and environment can be gathered and reported. An example embodiment can be integrated into the car's IVI system or on a smartphone application. The data related to the child's wellbeing and environment can be displayed with easy to program options to deal with different situations. For example, especially when the child is in a rear-facing car seat, the driver is unable to know what the temperature is like for the child and whether they are getting enough air conditioning or heat. An example embodiment can display an alert or automatically change the air conditioning in the back of the vehicle using a vehicle operational subsystem interface. The details of various example embodiments are provided below in connection with the accompanying figures.

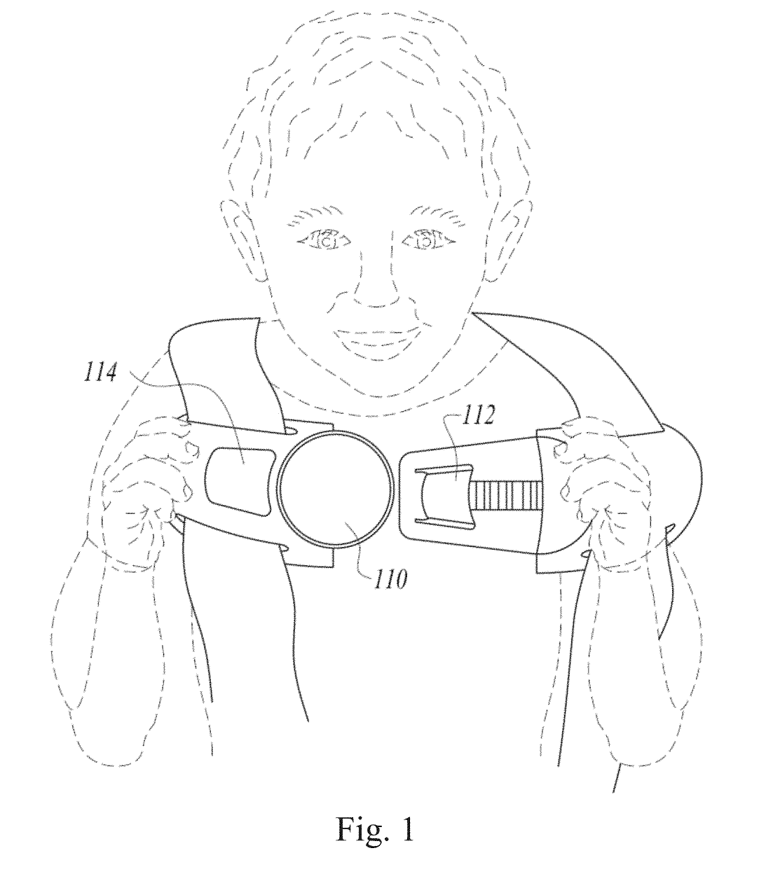

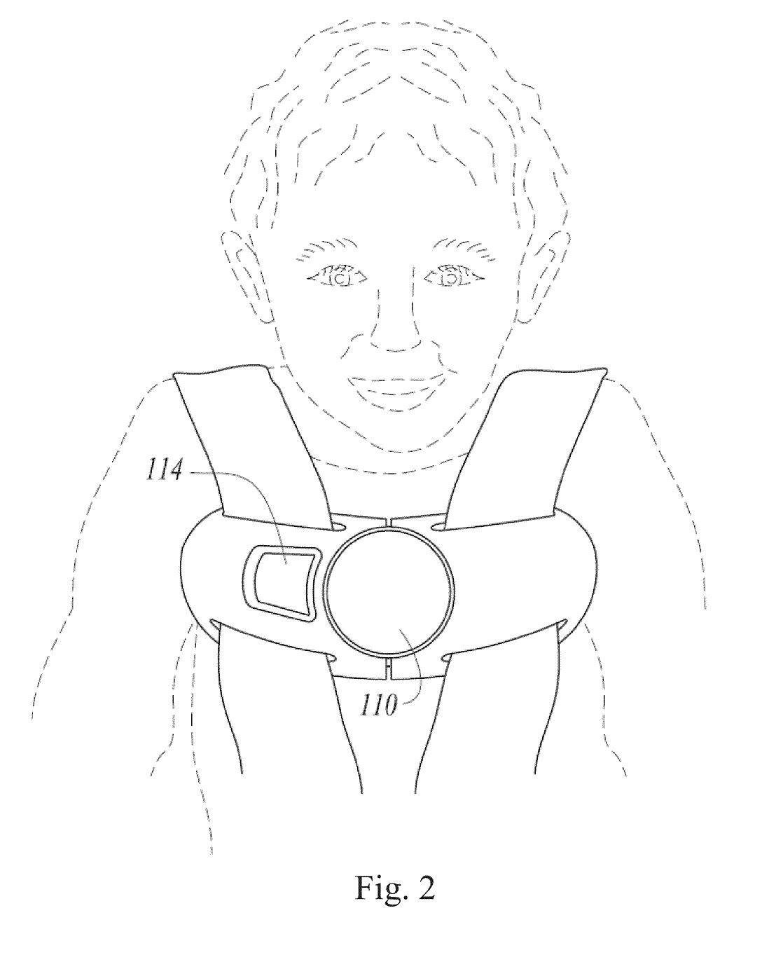

Referring now to FIGS. 1 and 2, the diagrams illustrate how a conventional child seat buckle mechanism can be latched in an example embodiment. In a conventional child seat, a typical latch includes two portions 110 and 112, which can be connected together and latched as shown in FIG. 2. A release mechanism 114 is typically provided on the latch mechanism to release the latch. However, these release mechanisms 114 for vehicle seat belts and child seats are often openly accessible on the surface of belt buckles as shown in FIGS. 1 and 2. Accidental contact of the release mechanism 114 opens the seat belt or child seat buckle and renders the seat belt or child seat useless in case of an accident or sudden stop. Children can sometimes release a seat belt or child seat in play endangering their own lives or the lives of others in the vehicle. As such, an example embodiment can integrate control logic, wireless data communication components, and a latch sensor, in addition to a variety of other sensors, (denoted herein as the child seat monitoring system) into a portion of the latch mechanism 110, into other portions of the child seat, or into a clip-on device that can be removably attached to the car seat. The child seat monitoring system can detect the release of the child seat latch mechanism and trigger one or more notifications in response.

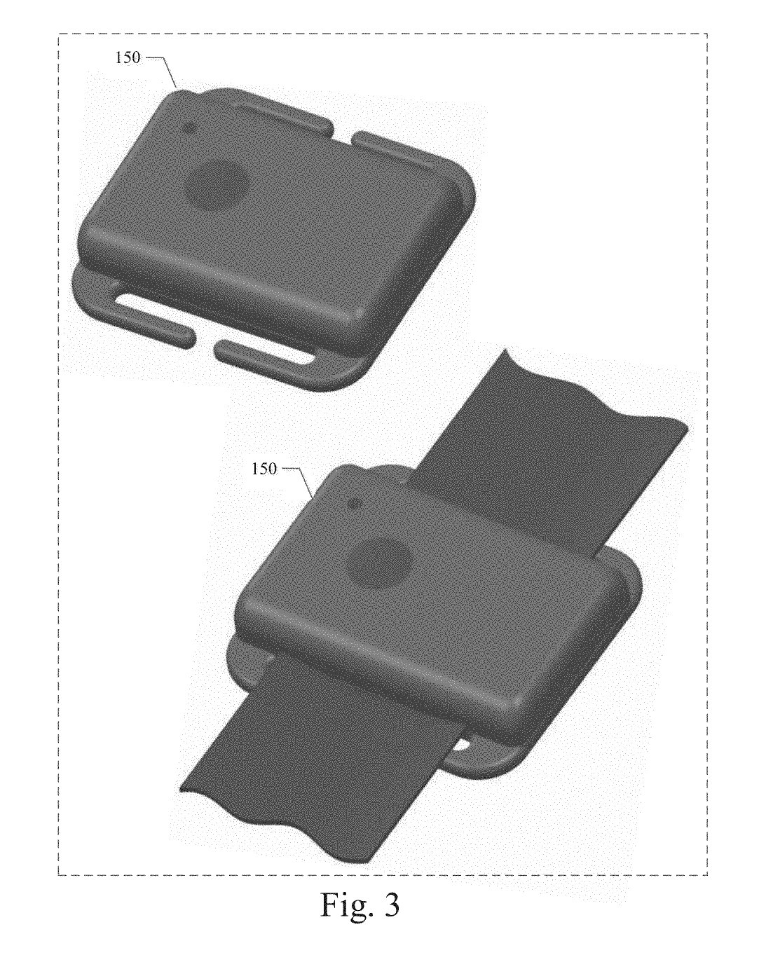

FIG. 3 illustrates another example embodiment of the child seat monitoring system 150 integrated into a single-side clip-on device that can be attached to a portion of the child seat restraints, harness, or strap(s) of atypical child car seat. In the particular embodiment shown, the clip-on device can be removably attached to a child car seat. As described in more detail below, the clip-on device with the integrated child seat monitoring system 150 can include a data processor, a wireless radio transceiver, a power storage unit (e.g., a battery), a set or array of sensors, and control logic executable by the data processor. The control logic can be configured to communicate with an application (app) running in a separate mobile device, an in-vehicle app, or an app running on a network resource. The control logic can also be configured to receive sensor data from the sensor array, detect various conditions or events related to the child in a car seat or the surrounding environment, and automatically send notifications or alerts to local or remote devices when various conditions or events are detected. The control logic can also be configured to send periodic status messages to wirelessly connected devices. As a result, the clip-on device can be used with a mobile device to monitor the status of a child in a car seat. For example, if the mobile device becomes out of range and no longer able to receive the notifications or alerts from the clip-on device, the mobile device app can be configured to send alerts to the parent or caregiver via the mobile device. The alerts/alarms can be configured to continue until the clip-on device is back in range of the mobile device or other corrective action is taken. If the parent/caregiver does not respond to the alarm in a timely manner, the mobile device app can be configured to send an emergency alert to third parties or emergency contacts. Using the Global Positioning System (GPS) and phone/text capabilities of the mobile device, the mobile device app can send detailed information about the child's last known status (e.g., car temperature, clip-on device status, GPS coordinates, etc.). If the emergency contacts also do not respond, the mobile device app can be further configured to issue an emergency call to 911. With an accelerometer and a load or motion sensor as part of the sensor array, the child seat monitoring system 150 integrated into the clip-on device can detect whether the child is in the car and properly secured in the car seat when the car is moving. Using a temperature/humidity sensor, the clip-on device can detect the temperature/humidity of the child's environment and alert the parent/caregiver if the car is too hot for the child. It will be apparent to those of ordinary skill in the art in view of the disclosure herein that a variety of other uses of the embodiments disclosed herein can be supported.

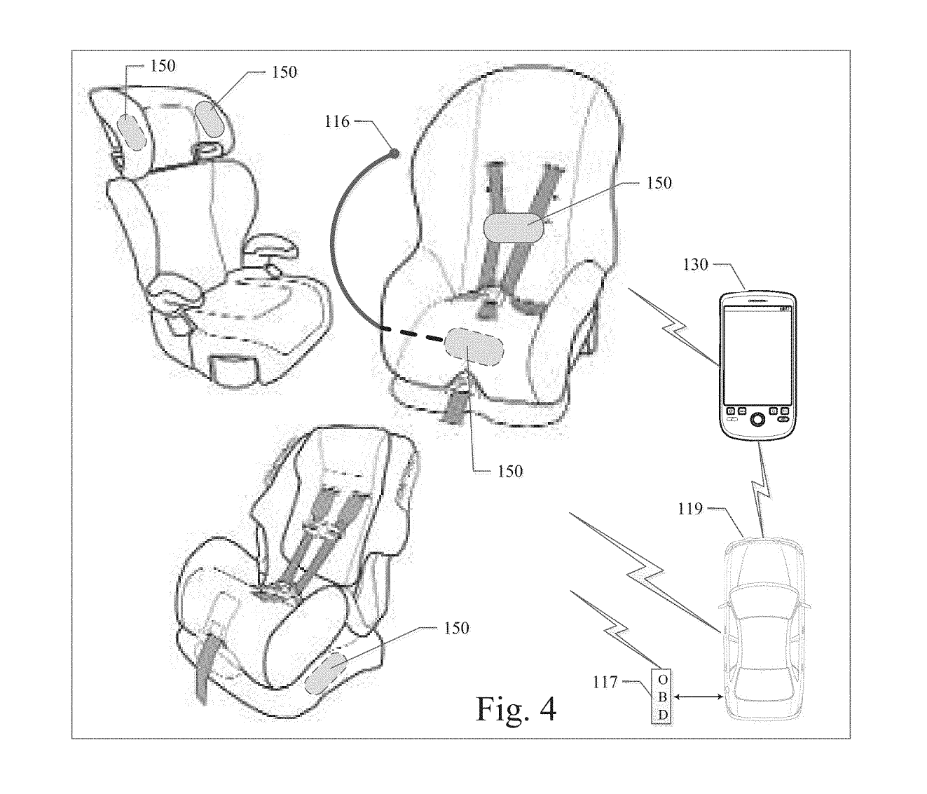

FIG. 4 illustrates other example embodiments of various types of child seats with one or more portions of the child seat monitoring system 150 integrated into various portions of the child seat. In a basic configuration, the child seat monitoring system 150 can be a single component that can be clipped to a strap or other portion of the child car seat. As described in more detail below, the child seat monitoring system 150 can be configured to be in wireless data communication with a mobile device 130 and/or a vehicle control module or vehicle operational subsystem 119. In other example configurations, such as those shown in FIG. 4, the child seat monitoring system 150 can be a single component or multiple components attached to or integrated into the child car seat in a variety of positions. In these other example configurations, the child seat monitoring system 150 can also be configured to be in wireless data communication with its multiple components and with a mobile device 130 and/or a vehicle control module or vehicle operational subsystem 119. Depending upon the capabilities of the particular set of sensors integrated into the particular embodiment of the child seat monitoring system 150, the child seat monitoring system 150 or one of its multiple components can be integrated into the child car seat in a suitable location. For example, an embodiment of the child seat monitoring system 150 that includes a child weight or load measuring sensor can include a portion integrated into the lower seat or back portion of the child car seat, as shown in FIG. 4, to enable the child weight or load measuring sensor to detect weight or pressure. As described in more detail below, the various embodiments of the child seat monitoring system 150 can be configured with one or more sensors (i.e., a sensor array) to detect various conditions and events in the environment in which the child car seat is located.

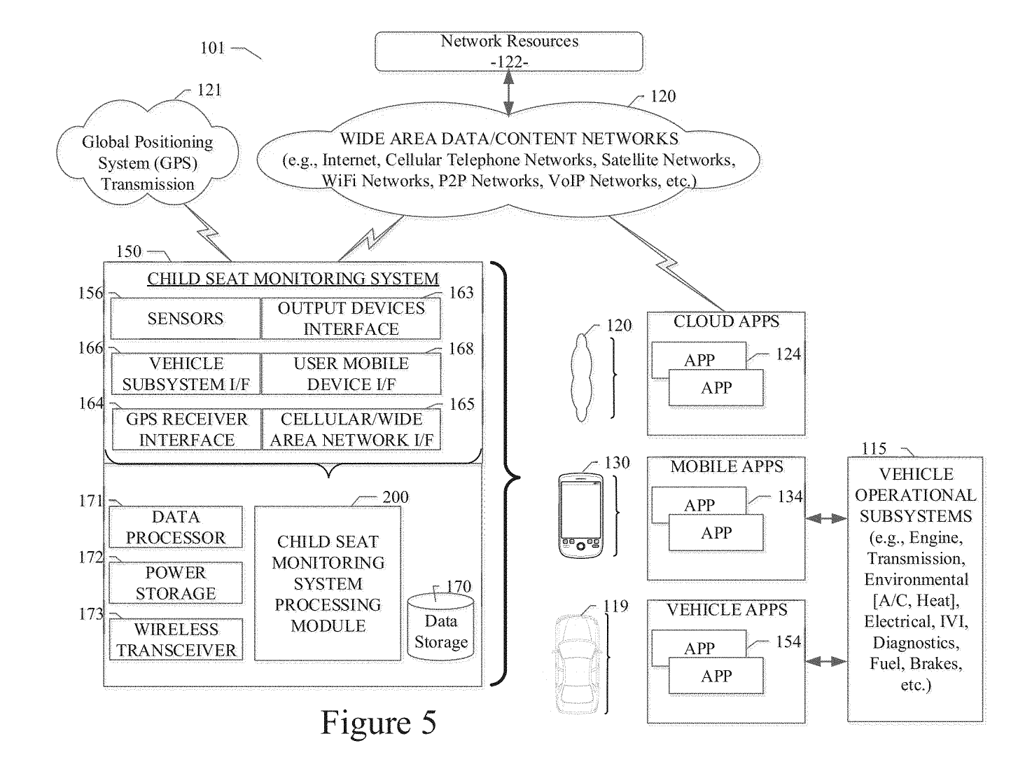

There are many different types of sensors and output devices that can be integrated into the child seat monitoring system 150 of an example embodiment. The sensor data outputs from these sensors can be provided and received by a sensor input module 156 of the child seat monitoring system 150 (see FIG. 5). These sensors or sensor arrays can include one or more of the following:

Capacitive Sensors—can be used to detect whether or not the child is in the car seat.

Force/Pressure/Weight Sensors—can be used to detect whether or not the child is in the car seat.

Motion Sensors—detects if the child is agitated, crying, or upset; detects if the child is moving around in the car; and detects if the child is shivering from being too cold.

Cameras—enables the driver to see the child in the car seat from the front seat of the vehicle or from a remote location. An example embodiment including a camera 116 is shown in FIG. 4. In other embodiments, the child seat monitoring system 150 can include computer vision analysis logic to perform facial analysis of the image of the child's face captured by the camera 116 and to analyze the child's face, motion, and mannerisms to detect happiness, agitation, distress, sadness, etc. Over time, the child seat monitoring system 150 including computer vision analysis logic can use machine learning techniques to correlate the child's facial expressions with particular responsive actions.

Temperature & Humidity Sensors—detects the temperature and humidity in the child's environment, detects the child's body temperature, if the sensor is placed closely enough to the child's body.

Accelerometers—detects movement, rate, and acceleration of the vehicle or the car seat itself, detects whether the child is in the car seat when the car is stationary or moving.

Air Quality Sensors—detects the air quality in the child's environment, detects carbon monoxide (CO) levels in the child's environment.

Water/Moisture Sensors—detects if the child has spilled anything while drinking in the car seat, detects excess levels of water or moisture in the child's environment.

Sound Sensors or Microphones—detects when the child (or others in the vehicle) is making noise, crying, etc., detects when a car door opens or closes, detects breaking glass or sounds in an accident.

Light sensors—detects the level of sun exposure the child is receiving.

Heart Rate sensors—detects the child's heart rate, especially in the event of an accident.

GPS receiver—enables the child seat monitoring system 150 to receive a GPS location of the vehicle or the car seat via the GPS Receiver Interface 164 (shown in FIG. 5 and described below). This feature enables the child seat monitoring system 150 to receive and report out a GPS location, if the car is in an accident or incident. The retrieval and use of GPS data is described in more detail below.

There are many different types of output devices that can also be integrated into and/or used with the child seat monitoring system 150 of an example embodiment. The output device data to these output devices can be processed and transmitted by the child seat monitoring system 150 via an output devices interface module 163 of the child seat monitoring system 150 (see FIG. 5). These output devices can include one or more of the following:

Speakers—enables the child seat monitoring system 150 to produce audible sounds for the child. The system can be used to speak to the child, play music specifically for the child to hear, etc.

Display devices—enables the child seat monitoring system 150 to produce visual images or video for the child. The system can be used to present entertaining, educational, or soothing imagery for the child.

An integrated cellular telephone communication module—enables the child seat monitoring system 150 to call, message, or otherwise notify police or others in the event of an accident or incident via the Cellular/Wide Area Network Interface 165 (shown in FIG. 5 and described below). The incident notification can include the current state of the child as determined from the sensor data obtained from the sensor array provided in a particular embodiment, such as the sensors described herein.

An interface 168 for the use of a separate mobile device 130 for communication is provided and described in more detail below.

An interface 165 for the use of a Wide Area Network 120 for communication is provided and described in more detail below.

An interface 166 for the use of various vehicle operational subsystems 115 for communication and control is provided and described in more detail below.

Buzzers/LEDs—enables the child seat monitoring system 150 to use a sound or light emitting device as feedback for a variety of uses.

As described above, these sensors grouped in a particular embodiment as a sensor array along with the particular output devices can be integrated with the child seat monitoring system 150 and embedded into the child car seat (e.g., see FIG. 4), implemented as an add-on device, such as a clip on the child car seat straps (e.g., see FIG. 3), integrated into a blanket or pad used with the child car seat, or used with the child seat monitoring system 150 via a provided interface. Through a wireless data communication protocol like Bluetooth™, WiFi, XBee™, etc. as described in more detail below, the child seat monitoring system 150 can receive sensor data from the sensor array, process the sensor data, and send notifications and information to the one or more output devices, including a display device in the front dashboard of the car via a vehicle operational subsystem and the vehicle IVI system or a display screen page in a smartphone application. The notification or information display can show some or all of the data received from the sensor array. Using a vehicle operational subsystem, the child seat monitoring system 150 can also communicate with and control various vehicle subsystems and components of the car (like the car horn, air conditioner, heater, etc.) either through connections via the IVI system or from connections via a connector to a standard Onboard Diagnostic (OBD) port 117 (see FIG. 4).

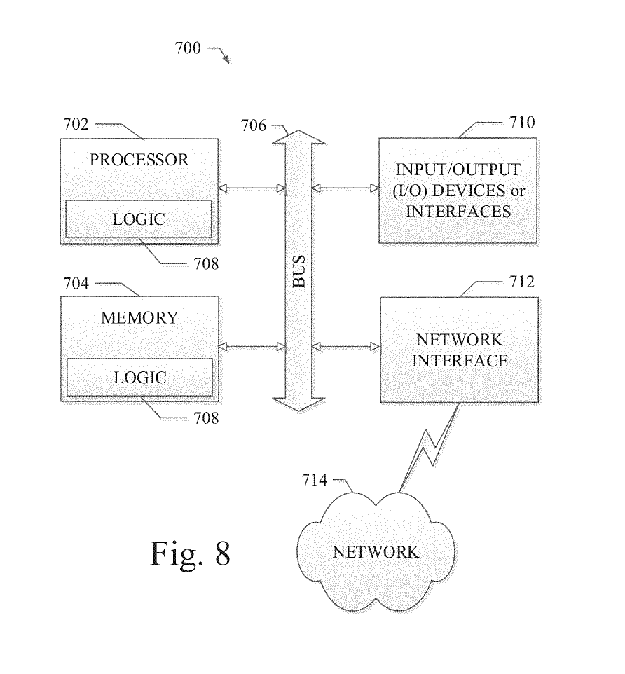

Referring now to FIG. 5, a block diagram illustrates an example ecosystem 101 in which a child seat monitoring system 150 and a child seat monitoring system processing module 200 of an example embodiment can be implemented. The child seat monitoring system processing module 200 can be implemented as software or firmware executing within the execution environment provided by child seat monitoring system 150. In an example embodiment, the child seat monitoring system 150 can be implemented as the mobile computing and/or communication system 700 as shown in FIG. 8 and described below. The functionality provided by the child seat monitoring system processing module 200 is described in more detail below.

Ecosystem 101 includes a variety of systems and components that can generate and/or deliver one or more sources of information/data and related services to the child seat monitoring system 150 and the child seat monitoring system processing module 200, which can be installed in or attached to a child car seat in vehicle 119. For example, a standard Global Positioning System (GPS) network 121 can generate geo-location data and timing data or other navigation information that can be received by an in-vehicle GPS receiver via a vehicle antenna. The child seat monitoring system 150 and the child seat monitoring system processing module 200 can receive this geo-location data, timing data, and navigation information via the GPS receiver interface 164, which can be used to connect the child seat monitoring system 150 with the in-vehicle GPS receiver to obtain the geo-location data, timing data, and navigation information.

Similarly, ecosystem 101 can include a wide area data/content network 120. The network 120 represents one or more conventional wide area data/content networks, such as the Internet, a cellular telephone network, satellite network, pager network, a wireless broadcast network, gaming network, WiFi network, peer-to-peer network, Voice over IP (VoIP) network, etc. One or more of these networks 120 can be used to connect a user or client system with network resources 122, such as websites, servers, call distribution sites, headend content delivery sites, or the like. The network resources 122 can receive or generate and/or distribute data, which can be received in vehicle 119 via one or more antennas. The network resources 122 can also host network cloud services, which can support the functionality used to compute or assist in processing data received from the sensor array and/or any related notifications. Antennas can serve to connect the child seat monitoring system 150 and the child seat monitoring system processing module 200 with the data/content network 120 via cellular, satellite, radio, or other conventional signal reception mechanisms. Such cellular data or content networks are currently available (e.g., Verizon™, AT&T™, T-Mobile™, etc.). Such satellite-based data or content networks are also currently available (e.g., SiriusXM™, HughesNet™, etc.). The conventional broadcast networks, such as AM/FM radio networks, pager networks, UHF networks, gaming networks, WiFi networks, peer-to-peer networks, Voice over IP (VoIP) networks, and the like are also well-known.

As shown in FIG. 5, the child seat monitoring system 150 and the child seat monitoring system processing module 200 can also push notifications to and receive control data from user mobile devices 130, which are located inside or proximately to the vehicle 119. The user mobile devices 130 can represent standard mobile devices, such as cellular phones, smartphones, personal digital assistants (PDA's), MP3 players, tablet computing devices (e.g., iPad™), laptop computers, CD players, and other mobile devices, which can produce, receive, and/or deliver data and content for the child seat monitoring system 150 and the child seat monitoring system processing module 200.

As shown in FIG. 5, the mobile devices 130 can also be in data communication with the network cloud 120. The mobile devices 130 can source data and content from internal memory components of the mobile devices 130 themselves or from network resources 122 via network 120. Additionally, mobile devices 130 can themselves include a GPS data receiver, accelerometers, WiFi triangulation, or other geo-location sensors or components in the mobile device, which can be used to determine the real-time geo-location of the user (via the mobile device) at any moment in time. In each case, the child seat monitoring system 150 and the child seat monitoring system processing module 200 can transmit or receive this data to/from the mobile devices 130 as shown in FIG. 5.

In various embodiments, the mobile device 130 interface and user interface between the child seat monitoring system 150 and the mobile devices 130 can be implemented in a variety of ways. For example, in one embodiment, the mobile device 130 interface between the child seat monitoring system 150 and the mobile devices 130 can be implemented using a Universal Serial Bus (USB) interface and associated connector. In another embodiment, the interface between the child seat monitoring system 150 and the mobile devices 130 can be implemented using a wireless protocol, such as WiFi or Bluetooth™ (BT). WiFi is a popular wireless technology allowing an electronic device to exchange data wirelessly over a computer network. Bluetooth™ is a well-known wireless technology standard for exchanging data over short distances. Using standard mobile device 130 interfaces, a mobile device 130 can be paired and/or synchronized with the child seat monitoring system 150 when the mobile device 130 is moved within a proximity region of the child seat monitoring system 150. The user mobile device interface 168 can be used to facilitate this pairing. Once the child seat monitoring system 150 is paired with the mobile device 130, the mobile device 130 can share information with the child seat monitoring system 150 and the child seat monitoring system processing module 200 in data communication therewith.

Referring again to FIG. 5 in an example embodiment as described above, the child seat monitoring system 150 and the child seat monitoring system processing module 200 can send data to and receive data from a variety of nodes in ecosystem 101, both local (e.g., within proximity of the child seat monitoring system 150) and remote (e.g., accessible via data network 120). These nodes can include receivers and transmitters of notifications, data, and control commands to/from proximate user mobile devices 130 (e.g., a mobile device proximately located in or near the vehicle 119), notifications, data, and control commands to/from network 120 cloud-based resources 122, and/or notifications, data, and control commands to/from an in-vehicle operational subsystem 115. Data related to the information received and the data processing performed by the child seat monitoring system processing module 200 can be retained in data storage 170 for later retrieval and use.

Referring still to FIG. 5, the example embodiment of ecosystem 101 can include vehicle operational subsystems 115. For embodiments that are implemented in or integrated with a vehicle 119, many standard vehicles include operational subsystems, such as electronic control units (ECUs), supporting monitoring/control subsystems for the engine, brakes, fuel, transmission, electrical system, emissions system, interior environment (air conditioning/heating), diagnostics, In-Vehicle Infotainment (IVI) systems, and the like. For example, data signals communicated from the vehicle operational subsystems 115 (e.g., ECUs of the vehicle 119) to the child seat monitoring system 150 via vehicle subsystem interface 166 may include information about the state of one or more of the components or subsystems of the vehicle 119. In particular, the data signals, which can be communicated from the vehicle operational subsystems 115 to a Controller Area Network (CAN) bus of the vehicle 119, can be received and processed by the child seat monitoring system 150 via vehicle subsystem interface 166. Embodiments of the systems and methods described herein can be used with substantially any mechanized system that uses a CAN bus or similar data communications bus as defined herein, including, but not limited to, industrial equipment, boats, trucks, machinery, or automobiles; thus, the term “car” or “vehicle” as used herein can include any such mechanized systems. Embodiments of the systems and methods described herein can also be used with any systems employing some form of network data communications; however, such network communications are not required.

In the example embodiment shown in FIG. 5, the child seat monitoring system 150 can also include a rendering system and other output devices to enable a user and/or child in the car seat to view and/or hear information, synthesized speech, spoken audio, content, and control prompts provided or controlled by or through the child seat monitoring system 150. The rendering system can include standard visual display devices (e.g., plasma displays, liquid crystal displays (LCDs), touchscreen displays, heads-up displays, or the like) and speakers or other audio output devices.

Additionally, other data and/or content (denoted herein as ancillary data) can be obtained from local and/or remote sources by the child seat monitoring system 150 as described above. The ancillary data can be used to augment or modify the operation of the child seat monitoring system processing module 200 based on a variety of factors including, user context (e.g., the identity, age, profile, and driving history of the user), the context in which the user is operating the vehicle (e.g., the location of the vehicle, the specified destination, direction of travel, speed, the time of day, the status of the vehicle, etc.), and a variety of other data obtainable from the variety of sensors or sources, local and remote, as described herein.

In a particular embodiment, the child seat monitoring system 150 and the child seat monitoring system processing module 200 can be implemented as in-vehicle components of vehicle 119. In various example embodiments, the child seat monitoring system 150 and the child seat monitoring system processing module 200 in data communication therewith can be implemented as integrated components or as separate components. In an example embodiment, the software components of the child seat monitoring system 150 and/or the child seat monitoring system processing module 200 can be dynamically upgraded, modified, and/or augmented by use of the data connection with the mobile devices 130 and/or the network resources 122 via network 120. The child seat monitoring system 150 can periodically query a mobile device 130 or a network resource 122 for updates or updates can be pushed to the child seat monitoring system 150.

Referring still to FIG. 5, example embodiments are illustrated in which the processing of various embodiments can be implemented by applications (apps) executing on any of a variety of platforms. As shown in FIG. 5, the processing performed by the child seat monitoring system processing module 200 can be implemented in whole or in part by an app 154 executing on the child seat monitoring system 150 of vehicle 119, an app 134 executing on the mobile device 130, and/or an app 124 executing at a network resource 122 by a network service in the network cloud 120. The app 154 running on the child seat monitoring system 150 of vehicle 119 can be executed by a data processor of the child seat monitoring system 150. The results of this processing can be provided directly to subsystems of the child seat monitoring system 150. The app 134 running on the mobile device 130 can be executed by a data processor of the mobile device 130. The process for installing and executing an app on a mobile device 130 is well-known to those of ordinary skill in the art. The results of this processing can be provided to the mobile device 130 itself and/or the child seat monitoring system 150 via the mobile device interface 168. The app 124 running at a network resource 122 by a network service in the network cloud 120 can be executed by a data processor at the network resource 122. The process for installing and executing an app at a network resource 122 is also well-known to those of ordinary skill in the art. The results of this processing can be provided to the mobile device 130 and/or the child seat monitoring system 150 via the network 120 and the mobile device interface 168 or the wide area network interface 165. As a result, the child seat monitoring system processing module 200 can be implemented in any of a variety of ways using the resources available in the ecosystem 101.

In the example embodiment shown in FIG. 5, the child seat monitoring system 150 can also include a data processor or controller 171, a power storage element 172 (e.g., a battery), and a wireless radio transceiver 173. The data processor 171 can be used to execute the control logic provided by the child seat monitoring system processing module 200. The power storage element 172 can be used to provide electrical power to the elements of the child seat monitoring system 150. The wireless radio transceiver 173 can be used to enable the child seat monitoring system 150 to wirelessly communicate with other ecosystem 101 components as described above.

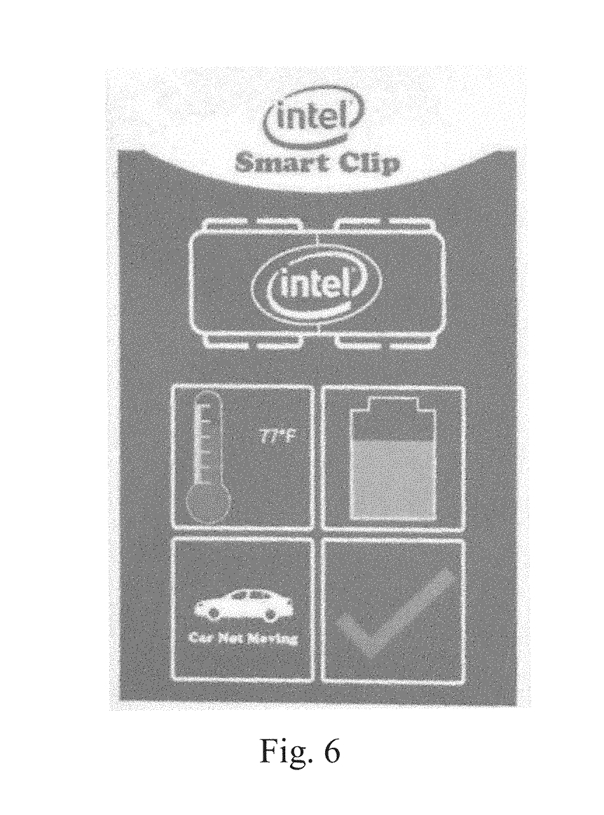

Referring now to FIG. 6, an example embodiment is illustrated in which a mobile device app 134 can receive sensor data from the child seat monitoring system 150 and produce an information or notification page on a mobile device user interface. In the example shown in FIG. 6, the child seat monitoring system 150 can report the temperature within the child's environment based on data received from a temperature sensor on or near the child car seat, the electrical power level reported by the vehicle battery subsystem, an indication whether or not the vehicle is moving based on an accelerometer sensor, GPS data, or information from a vehicle operational subsystem, and an indication whether the current status of the sensor array is within (or not within) a pre-determined threshold defining a satisfactory or unsatisfactory condition in the child's environment. It will be apparent to those of ordinary skill in the art that, given the system and processes disclosed herein, a variety of other conditions, events, and status can be shown to a user (local or remote) via an app 134 running on a mobile device 130, an app 154 running on the child seat monitoring system 150 of vehicle 119, and/or an app 124 running at a network resource 122 by a network service in the network cloud 120.

Thus, as described herein in various example embodiments, the child seat monitoring system 150 and the child seat monitoring system processing module 200 can perform child car seat safety detection and notification in a variety of ways. As a result, the various embodiments allow the parents or guardians of children to ensure the safety and comfort of children securely fastened into a child car seat.

The various embodiments described herein provide several advantages, including:

Enabling automatic detection of the presence and condition of the child in a child car seat and to entertain them with their favorite music or television show sounds and/or images;

Enabling the driver (or other authorized person/guardian) to watch the child while driving without having to look back;

Enabling the driver (or other authorized person/guardian) to communicate with the child without having to turn back;

Enabling the driver (or other authorized person/guardian) to play music or recorded dialogue to the child to help calm them. The speakers can be placed close to the child's ear giving them the impression the parent is near;

Enabling the driver (or other authorized person/guardian) to analyze and display the child's state (e.g., through sensor data and analysis);

Determining if a parent or guardian is leaving the child unattended in the car and alerting them (or others) through a variety of means, including through the car alarm, through a car notification system (e.g., like when keys are left in the ignition), using the car horn, via a phone application, etc.;

Enabling the driver (or other authorized person/guardian) to remotely receive information related to the child's condition or environment, if the child is left in the car;

Enabling the driver (or other authorized person/guardian) to remotely monitor and control the child seat monitoring system, such as the child seat monitoring system battery state;

Enabling the driver (or other authorized person/guardian) to remotely monitor and control vehicle systems, such as the vehicle air conditioner (A/C) and the IVI system state;

Enabling automatic local and remote notification of one or more third parties in the event of a car accident, emergency situation, or if the child is left unattended in the car for a pre-determined period of time. The automatic remote notification can include automatically calling the police or first responders and alerting them that there was a car accident, an emergency situation, or the child was left unattended in the car. The automatic remote notification can report out the child's current health state, location, and the length of time the child has been unattended in the vehicle since the car was turned off or stopped, etc.;

Alerting the driver (or other authorized person/guardian) if the child's seat belt is unclipped;

Reporting the length of time the child is in the car seat;

Enabling multiple authorized people to monitor the child's state through the IVI system or a smartphone. For example, if the child is in the car with a baby sitter, the parent can get notifications about the child's location and well-being;

Enabling analysis of a child's weight relative to the weight/size specifications of a car seat in which they are positioned; and

Triggering an LED and/or buzzer indicator when a phone or IVI system is connected to the car seat.

It will be apparent to those of ordinary skill in the art that many other use cases can be enabled and supported by the various embodiments described herein. In a particular embodiment, the child seat monitoring system 150 can be implemented in a clip-on device that can be removably attached to a child car seat (e.g., see FIG. 3). When attached, the clip-on device can automatically pair with a proximate mobile device or smartphone in a manner described above. Through the smartphone, the clip-on device can notify or send an alarm to the caregiver when the smartphone has travelled too far from the clip-on device when the clip-on device is active. In this embodiment, the clip-on device can also report extreme temperatures in the child's environment. As a result, the various embodiments described herein can prevent children in car seats from experiencing hypothermia or hyperthermia, which could lead to injury or death. In the example embodiment as described herein, the clip-on device can communicate with any smartphone over Bluetooth™ or other wireless data communication protocol. The clip-on device can detect when the child is strapped into the child car seat and when the parent or caregiver walks away and the Bluetooth™ connection disconnects. Upon detection of such an event by the child seat monitoring system 150 in the clip-on device, the child seat monitoring system 150 can send an alert notification to the parent or caregiver's mobile device and cause the mobile device, for example, to set off an audible, visual, or tactile alarm every X seconds at maximum volume and vibration until the parent or caregiver returns and actually disconnects or deactivates the clip-on device. As a result, children are protected from being inadvertently left alone in a vehicle.

As described for various embodiments above, the child seat monitoring system 150 in the clip-on device can hold a number of sensors in a sensor array to monitor the condition of a child in a car seat and the surrounding environment. In various embodiments, these sensors or the sensor array can include: a chest clip connection status, a car in motion status, a temperature sensor, an accelerometer, a heart rate sensor, an oxygen level sensor, and a chest clip position sensor. Because the particular example embodiment is a clip-on device, the device can be used with any car seat without any modifications. In the example embodiment, the clip-on device is configured to communicate with any proximate smartphone, so users do not need to carry additional devices. A variety of sensors can be added to the sensor array so the clip-on device can detect a variety of conditions and events related to the condition of a child in a car seat and the surrounding environment.

In an alternative embodiment, in the event of having multiple caregivers and parents in the same car, an embodiment can use Bluetooth™ Low Energy (BLE) advertising instead of single mobile device pairing. BLE advertising mode data transmission sends out data to any listening smartphone. With the advertising mode method, it does not matter how many children are using the clip-on device or how many caregivers are receiving the information. In this embodiment, the child seat monitoring system 150 can send notifications and alerts to multiple mobile devices in the case of a condition or event detection related to a child in a car seat. Because multiple mobile devices can be receiving the notifications or alerts from the clip-on device at the same time, the applications running on the mobile devices can be configured to communicate with one another so a response to the notification or alert can be coordinated.

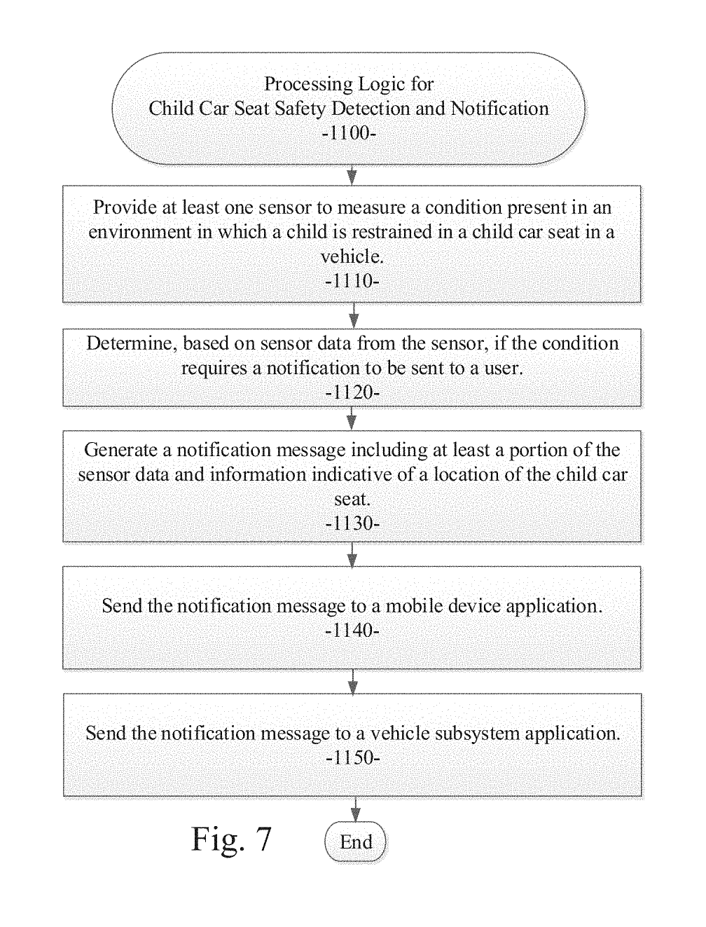

Referring now to FIG. 7, a processing flow diagram illustrates an example embodiment of a method 1100 as described herein. The method 1100 of an example embodiment includes: providing at least one sensor to measure a condition present in an environment in which a child is restrained in a child car seat in a vehicle (processing block 1110); determining, based on sensor data from the sensor, if the condition requires a notification to be sent to a user (processing block 1120); generating a notification message including at least a portion of the sensor data and information indicative of a location of the child car seat (processing block 1130); sending the notification message to a mobile device application (processing block 1140); and sending the notification message to a vehicle subsystem application (processing block 1150).

Embodiments described herein are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size can be manufactured. In addition, well-known power/ground connections to integrated circuit (IC) chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one of ordinary skill in the art. Where specific details (e.g., circuits) are set forth in order to describe example embodiments, it should be apparent to one of ordinary skill in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Child seat monitoring system 150 may include one or more wireless radio transceivers, in some embodiments. Each of the wireless transceivers may be implemented as physical wireless adapters or virtual wireless adapters, sometimes referred to as “hardware radios” and “software radios,” respectively. A single physical wireless adapter may be virtualized (e.g., using software) into multiple virtual wireless adapters. A physical wireless adapter typically connects to a hardware-based wireless access point. A virtual wireless adapter typically connects to a software-based wireless access point, sometimes referred to as a “SoftAP.” For instance, a virtual wireless adapter may allow ad hoc communications between peer devices, such as a smartphone and a desktop computer or notebook computer. Various embodiments may use a single physical wireless adapter implemented as multiple virtual wireless adapters, multiple physical wireless adapters, multiple physical wireless adapters each implemented as multiple virtual wireless adapters, or some combination thereof. The example embodiments described herein are not limited in this respect.

The wireless radio transceivers may include or implement various communication techniques to allow the child seat monitoring system 150 to communicate with other electronic devices. For instance, the wireless transceivers may implement various types of standard communication elements designed to be interoperable with a network, such as one or more communications interfaces, network interfaces, network interface cards (NIC), radios, wireless transmitters/receivers (transceivers), wired and/or wireless communication media, physical connectors, and so forth.

By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other parts of the spectrum, and other wireless media.

In various embodiments, the child seat monitoring system 150 may implement different types of wireless transceivers. Each of the wireless transceivers may implement or utilize a same or different set of communication parameters to communicate information between various electronic devices. In one embodiment, for example, each of the wireless transceivers may implement or utilize a different set of communication parameters to communicate information between child seat monitoring system 150 and any number of other devices. Some examples of communication parameters may include without limitation a communication protocol, a communication standard, a radio-frequency (RF) band, a radio, a transmitter/receiver (transceiver), a radio processor, a baseband processor, a network scanning threshold parameter, a radio-frequency channel parameter, an access point parameter, a rate selection parameter, a frame size parameter, an aggregation size parameter, a packet retry limit parameter, a protocol parameter, a radio parameter, modulation and coding scheme (MCS), acknowledgement parameter, media access control (MAC) layer parameter, physical (PHY) layer parameter, and any other communication parameters affecting operations for the wireless transceivers. The example embodiments described herein are not limited in this respect.

In various embodiments, the wireless transceivers may implement different communication parameters offering varying bandwidths, communications speeds, or transmission ranges. For instance, a first wireless transceiver may include a short-range interface implementing suitable communication parameters for shorter range communication of information, while a second wireless transceiver may include a long-range interface implementing suitable communication parameters for longer range communication of information.

In various embodiments, the terms “short-range” and “long-range” may be relative terms referring to associated communications ranges (or distances) for associated wireless transceivers as compared to each other rather than an objective standard. In one embodiment, for example, the term “short-range” may refer to a communications range or distance for the first wireless transceiver that is shorter than a communications range or distance for another wireless transceiver implemented for child seat monitoring system 150, such as a second wireless transceiver. Similarly, the term “long-range” may refer to a communications range or distance for the second wireless transceiver that is longer than a communications range or distance for another wireless transceiver implemented for the child seat monitoring system 150, such as the first wireless transceiver. The example embodiments described herein are not limited in this respect.

In one embodiment, for example, the wireless transceiver may include a radio designed to communicate information over a wireless personal area network (WPAN) or a wireless local area network (WLAN). The wireless transceiver may be arranged to provide data communications functionality in accordance with different types of lower range wireless network systems or protocols. Examples of suitable WPAN systems offering lower range data communication services may include a Bluetoothυ system as defined by the Bluetooth Special Interest Group, an infra-red (IR) system, an Institute of Electrical and Electronics Engineers (IEEE™) 802.15 system, a DASH7 system, wireless universal serial bus (USB), wireless high-definition (HD), an ultra-side band (UWB) system, and similar systems. Examples of suitable WLAN systems offering lower range data communications services may include the IEEE 802.xx series of protocols, such as the IEEE 802.11a/b/g/n series of standard protocols and variants (also referred to as “WiFi”). It may be appreciated that other wireless techniques may be implemented. The example embodiments described herein are not limited in this respect. In one embodiment, for example, the wireless transceiver may include a radio designed to communicate information over a wireless metropolitan area network (WMAN), a wireless wide area network (WWAN), or a cellular radiotelephone system. Another wireless transceiver may be arranged to provide data communications functionality in accordance with different types of longer range wireless network systems or protocols. Examples of suitable wireless network systems offering longer range data communication services may include the IEEE 802.xx series of protocols, such as the IEEE 802.11a/b/g/n series of standard protocols and variants, the IEEE 802.16 series of standard protocols and variants, the IEEE 802.20 series of standard protocols and variants (also referred to as “Mobile Broadband Wireless Access”), and so forth. Alternatively, the wireless transceiver may include a radio designed to communicate information across data networking links provided by one or more cellular radiotelephone systems. Examples of cellular radiotelephone systems offering data communications services may include GSM with General Packet Radio Service (GPRS) systems (GSM/GPRS), CDMA/1xRTT systems, Enhanced Data Rates for Global Evolution (EDGE) systems, Evolution Data Only or Evolution Data Optimized (EV-DO) systems, Evolution For Data and Voice (EV-DV) systems, High Speed Downlink Packet Access (HSDPA) systems, High Speed Uplink Packet Access (HSUPA), and similar systems. It may be appreciated that other wireless techniques may be implemented. The example embodiments described herein are not limited in this respect.

Although not shown, child seat monitoring system 150 may further include one or more device resources commonly implemented for electronic devices, such as various computing and communications platform hardware and software components typically implemented by a personal electronic device. Some examples of device resources may include without limitation a co-processor, a graphics processing unit (GPU), a chipset/platform control logic, an input/output (I/O) device, computer-readable media, network interfaces, portable power supplies (e.g., a battery), application programs, system programs, and so forth. The example embodiments described herein are not limited in this respect.

Included herein is a set of logic flows representative of example methodologies for performing novel aspects of the disclosed architecture. While, for purposes of simplicity of explanation, the one or more methodologies shown herein are shown and described as a series of acts, those of ordinary skill in the art will understand and appreciate that the methodologies are not limited by the order of acts. Some acts may, in accordance therewith, occur in a different order and/or concurrently with other acts from those shown and described herein. For example, those of ordinary skill in the art will understand and appreciate that a methodology can alternatively be represented as a series of interrelated states or events, such as in a state diagram. Moreover, not all acts illustrated in a methodology may be required for a novel implementation. A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The example embodiments disclosed herein are not limited in this respect.

The various elements of the example embodiments as previously described with reference to the figures may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The example embodiments described herein provide a technical solution to a technical problem. The various embodiments improve the functioning of the electronic device by providing systems and methods for child car seat safety detection and notification. The various embodiments also serve to transform the state of various system components based on a dynamically determined system context. Additionally, the various embodiments effect an improvement in a variety of technical fields including the fields of dynamic data processing, child car seat safety detection and notification, mobile computing, information sharing, and mobile communications.

FIG. 8 shows a diagrammatic representation of a machine in the example form of an electronic device, such as a mobile computing and/or communication system 700 within which a set of instructions when executed and/or processing logic when activated may cause the machine to perform any one or more of the methodologies described and/or claimed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), a cellular telephone, a smartphone, a web appliance, a set-top box (STB), a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example mobile computing and/or communication system 700 includes a data processor 702 (e.g., a System-on-a-Chip [SoC], general processing core, graphics core, and optionally other processing logic) and a memory 704, which can communicate with each other via a bus or other data transfer system 706. The mobile computing and/or communication system 700 may further include various input/output (I/O) devices and/or interfaces 710, such as a touchscreen display and optionally a network interface 712. In an example embodiment, the network interface 712 can include one or more radio transceivers configured for compatibility with any one or more standard wireless and/or cellular protocols or access technologies (e.g., 2nd (2G), 2.5, 3rd (3G), 4th (4G) generation, and future generation radio access for cellular systems, Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like). Network interface 712 may also be configured for use with various other wired and/or wireless communication protocols, including TCP/IP, UDP, SIP, SMS, RTP, WAP, CDMA, TDMA, UMTS, UWB, WiFi, WiMax, Bluetooth™, IEEE 802.11x, and the like. In essence, network interface 712 may include or support virtually any wired and/or wireless communication mechanisms by which information may travel between the mobile computing and/or communication system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, and/or associated caches and computing systems) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

With general reference to notations and nomenclature used herein, the description presented herein may be disclosed in terms of program procedures executed on a computer or a network of computers. These procedural descriptions and representations may be used by those of ordinary skill in the art to convey their work to others of ordinary skill in the art.

A procedure is generally conceived to be a self-consistent sequence of operations performed on electrical, magnetic, or optical signals capable of being stored, transferred, combined, compared, and otherwise manipulated. These signals may be referred to as bits, values, elements, symbols, characters, terms, numbers, or the like. It should be noted, however, that all of these and similar terms are to be associated with the appropriate physical quantities and are merely convenient labels applied to those quantities. Further, the manipulations performed are often referred to in terms such as adding or comparing, which operations may be executed by one or more machines. Useful machines for performing operations of various embodiments may include general-purpose digital computers or similar devices. Various embodiments also relate to apparatus or systems for performing these operations. This apparatus may be specially constructed for a purpose, or it may include a general-purpose computer as selectively activated or reconfigured by a computer program stored in the computer. The procedures presented herein are not inherently related to a particular computer or other apparatus. Various general-purpose machines may be used with programs written in accordance with teachings herein, or it may prove convenient to construct more specialized apparatus to perform methods described herein.

In various embodiments as described herein, example embodiments include at least the following examples.

An apparatus comprising: at least one sensor to measure a condition present in an environment in which a child is restrained in a child car seat in a vehicle; a data processor to receive and process sensor data from the sensor; and a child seat monitoring system processing module, executable by the data processor, configured to: determine, based on the sensor data, if the condition requires a notification to be sent to a user; generate a notification message including at least a portion of the sensor data and information indicative of a location of the child car seat; send the notification message to a mobile device application; and send the notification message to a vehicle subsystem application.

The apparatus as claimed above wherein the at least one sensor is of a type from the group consisting of: a capacitive sensor, a pressure sensor, a weight sensor, a motion sensor, a temperature sensor, a humidity sensor, an accelerometer, an air quality sensor, a moisture sensor, a sound sensor, a light sensor, and a global positioning system (GPS) receiver.

The apparatus as claimed above wherein the apparatus is configured for attachment to a harness or strap of a child car seat.

The apparatus as claimed above wherein the child seat monitoring system processing module being further configured to receive a control signal from the mobile device application.

The apparatus as claimed above wherein the child seat monitoring system processing module being further configured to send a control signal to a vehicle operational subsystem of the vehicle to modify the operation of the vehicle operational subsystem.

The apparatus as claimed above wherein the child seat monitoring system processing module being further configured to generate a notification message if the temperature in the vehicle exceeds a pre-determined threshold.

The apparatus as claimed above wherein the child seat monitoring system processing module being further configured to generate a notification message if a latch on the child car seat is detached.

A method comprising: providing at least one sensor to measure a condition present in an environment in which a child is restrained in a child car seat in a vehicle; determining, based on sensor data from the sensor, if the condition requires a notification to be sent to a user; generating a notification message including at least a portion of the sensor data and information indicative of a location of the child car seat; sending the notification message to a mobile device application; and sending the notification message to a vehicle subsystem application.

The method as claimed above wherein the at least one sensor is of a type from the group consisting of: a capacitive sensor, a pressure sensor, a weight sensor, a motion sensor, a temperature sensor, a humidity sensor, an accelerometer, an air quality sensor, a moisture sensor, a sound sensor, a light sensor, and a global positioning system (GPS) receiver.

The method as claimed above including attaching the sensor to a harness or strap of a child car seat.

The method as claimed above including receiving a control signal from the mobile device application.

The method as claimed above including sending a control signal to a vehicle operational subsystem of the vehicle to modify the operation of the vehicle operational subsystem.

The method as claimed above including generating a notification message if the temperature in the vehicle exceeds a pre-determined threshold.

The method as claimed above including generating a notification message if a latch on the child car seat is detached.

A system comprising: a mobile device; a vehicle subsystem; and a child seat monitoring system including: at least one sensor to measure a condition present in an environment in which a child is restrained in a child car seat in a vehicle; a data processor to receive and process sensor data from the sensor; and a child seat monitoring system processing module, executable by the data processor, configured to: determine, based on the sensor data, if the condition requires a notification to be sent to a user; generate a notification message including at least a portion of the sensor data and information indicative of a location of the child car seat; send the notification message to a mobile device application running on the mobile device; and send the notification message to a vehicle subsystem application running on the vehicle subsystem.

The system as claimed above wherein the at least one sensor is of a type from the group consisting of: a capacitive sensor, a pressure sensor, a weight sensor, a motion sensor, a temperature sensor, a humidity sensor, an accelerometer, an air quality sensor, a moisture sensor, a sound sensor, a light sensor, and a global positioning system (GPS) receiver.

The system as claimed above wherein the sensor is configured for attachment to a harness or strap of a child car seat.

The system as claimed above wherein the child seat monitoring system processing module being further configured to receive a control signal from the mobile device application.

The system as claimed above wherein the child seat monitoring system processing module being further configured to send a control signal to a vehicle operational subsystem of the vehicle to modify the operation of the vehicle operational subsystem.

The system as claimed above wherein the child seat monitoring system processing module being further configured to generate a notification message if the temperature in the vehicle exceeds a pre-determined threshold.

The system as claimed above wherein the child seat monitoring system processing module being further configured to generate a notification message if a latch on the child car seat is detached.

A non-transitory machine-useable storage medium embodying instructions which, when executed by a machine, cause the machine to: interface with at least one sensor to measure a condition present in an environment in which a child is restrained in a child car seat in a vehicle; determine, based on sensor data from the sensor, if the condition requires a notification to be sent to a user; generate a notification message including at least a portion of the sensor data and information indicative of a location of the child car seat; send the notification message to a mobile device application; and send the notification message to a vehicle subsystem application.

The machine-useable storage medium as claimed above wherein the at least one sensor is of a type from the group consisting of: a capacitive sensor, a pressure sensor, a weight sensor, a motion sensor, a temperature sensor, a humidity sensor, an accelerometer, an air quality sensor, a moisture sensor, a sound sensor, a light sensor, and a global positioning system (GPS) receiver.

The machine-useable storage medium as claimed above wherein the sensor is attached to a harness or strap of a child car seat.

The machine-useable storage medium as claimed above wherein the instructions being further configured to receive a control signal from the mobile device application.

The machine-useable storage medium as claimed above wherein the instructions being further configured to send a control signal to a vehicle operational subsystem of the vehicle to modify the operation of the vehicle operational subsystem.

The machine-useable storage medium as claimed above wherein the instructions being further configured to generate a notification message if the temperature in the vehicle exceeds a pre-determined threshold.

The machine-useable storage medium as claimed above wherein the instructions being further configured to generate a notification message if a latch on the child car seat is detached.

An apparatus comprising: at least one sensing means to measure a condition present in an environment in which a child is restrained in a child car seat in a vehicle; a data processing means to receive and process sensor data from the sensing means; and a child seat monitoring means, executable by the data processing means, configured to: determine, based on the sensor data, if the condition requires a notification to be sent to a user; generate a notification message including at least a portion of the sensor data and information indicative of a location of the child car seat; send the notification message to a mobile device application; and send the notification message to a vehicle subsystem application.

The apparatus as claimed above wherein the at least one sensing means is of a type from the group consisting of: a capacitive sensor, a pressure sensor, a weight sensor, a motion sensor, a temperature sensor, a humidity sensor, an accelerometer, an air quality sensor, a moisture sensor, a sound sensor, a light sensor, and a global positioning system (GPS) receiver.

The apparatus as claimed above wherein the apparatus is configured for attachment to a harness or strap of a child car seat.

The apparatus as claimed above wherein the child seat monitoring means being further configured to receive a control signal from the mobile device application.

The apparatus as claimed above wherein the child seat monitoring means being further configured to send a control signal to a vehicle operational subsystem of the vehicle to modify the operation of the vehicle operational subsystem.

The apparatus as claimed above wherein the child seat monitoring means being further configured to generate a notification message if the temperature in the vehicle exceeds a pre-determined threshold.

The apparatus as claimed above wherein the child seat monitoring means being further configured to generate a notification message if a latch on the child car seat is detached.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus comprising:
at least one sensor to measure a condition present in an environment in which a child is restrained in a child car seat in a vehicle;
a data processor to receive and process sensor data from the sensor; and
a child seat monitoring system processing module, executable by the data processor, configured to:
determine, based on the sensor data, if the condition requires a notification to be sent to a user;
generate a notification message including at least a portion of the sensor data and information indicative of a location of the child car seat;
send the notification message to a mobile device application; and
send the notification message to a vehicle subsystem application.

2. The apparatus of claim 1 wherein the child seat monitoring system processing module being further configured to receive a control signal from the mobile device application.

3. The apparatus of claim 1 wherein the child seat monitoring system processing module being further configured to send a control signal to a vehicle operational subsystem of the vehicle to modify the operation of the vehicle operational subsystem.

4. The apparatus of claim 1 wherein the child seat monitoring system processing module being further configured to generate a notification message if the temperature in the vehicle exceeds a pre-determined threshold.

5. The apparatus of claim 1 wherein the child seat monitoring system processing module being further configured to generate a notification message if a latch on the child car seat is detached.

6. A method comprising:
providing at least one sensor to measure a condition present in an environment in which a child is restrained in a child car seat in a vehicle;
determining, based on sensor data from the sensor, if the condition requires a notification to be sent to a user;
generating a notification message including at least a portion of the sensor data and information indicative of a location of the child car seat;
sending the notification message to a mobile device application; and
sending the notification message to a vehicle subsystem application.

7. The method of claim 6 including receiving a control signal from the mobile device application.

8. The method of claim 6 including sending a control signal to a vehicle operational subsystem of the vehicle to modify the operation of the vehicle operational subsystem.

9. The method of claim 6 including generating a notification message if the temperature in the vehicle exceeds a pre-determined threshold.

10. The method of claim 6 including generating a notification message if a latch on the child car seat is detached.

11. A system comprising:
a mobile device;
a vehicle subsystem; and
a child seat monitoring system including:
at least one sensor to measure a condition present in an environment in which a child is restrained in a child car seat in a vehicle;
a data processor to receive and process sensor data from the sensor; and
a child seat monitoring system processing module, executable by the data processor, configured to:
determine, based on the sensor data, if the condition requires a notification to be sent to a user;
generate a notification message including at least a portion of the sensor data and information indicative of a location of the child car seat;
send the notification message to a mobile device application running on the mobile device; and
send the notification message to a vehicle subsystem application running on the vehicle subsystem.

12. The system of claim 11 wherein the child seat monitoring system processing module being further configured to receive a control signal from the mobile device application.

13. The system of claim 11 wherein the child seat monitoring system processing module being further configured to send a control signal to a vehicle operational subsystem of the vehicle to modify the operation of the vehicle operational subsystem.

14. The system of claim 11 wherein the child seat monitoring system processing module being further configured to generate a notification message if the temperature in the vehicle exceeds a pre-determined threshold.

15. The system of claim 11 wherein the child seat monitoring system processing module being further configured to generate a notification message if a latch on the child car seat is detached.

16. A non-transitory machine-useable storage medium embodying instructions which, when executed by a machine, cause the machine to:
interface with at least one sensor to measure a condition present in an environment in which a child is restrained in a child car seat in a vehicle;
determine, based on sensor data from the sensor, if the condition requires a notification to be sent to a user;
generate a notification message including at least a portion of the sensor data and information indicative of a location of the child car seat;
send the notification message to a mobile device application; and
send the notification message to a vehicle subsystem application.

17. The machine-useable storage medium of claim 16 wherein the instructions being further configured to receive a control signal from the mobile device application.

18. The machine-useable storage medium of claim 16 wherein the instructions being further configured to send a control signal to a vehicle operational subsystem of the vehicle to modify the operation of the vehicle operational subsystem.

19. The machine-useable storage medium of claim 16 wherein the instructions being further configured to generate a notification message if the temperature in the vehicle exceeds a pre-determined threshold.

20. The machine-useable storage medium of claim 16 wherein the instructions being further configured to generate a notification message if a latch on the child car seat is detached.

21. An apparatus comprising:
at least one sensing means to measure a condition present in an environment in which a child is restrained in a child car seat in a vehicle;
a data processing means to receive and process sensor data from the sensing means; and
a child seat monitoring means, executable by the data processing means, configured to:
determine, based on the sensor data, if the condition requires a notification to be sent to a user;
generate a notification message including at least a portion of the sensor data and information indicative of a location of the child car seat;
send the notification message to a mobile device application; and
send the notification message to a vehicle subsystem application.

22. The apparatus of claim 21 wherein the child seat monitoring means being further configured to receive a control signal from the mobile device application.

23. The apparatus of claim 21 wherein the child seat monitoring means being further configured to send a control signal to a vehicle operational subsystem of the vehicle to modify the operation of the vehicle operational subsystem.

24. The apparatus of claim 21 wherein the child seat monitoring means being further configured to generate a notification message if the temperature in the vehicle exceeds a pre-determined threshold.

25. The apparatus of claim 21 wherein the child seat monitoring means being further configured to generate a notification message if a latch on the child car seat is detached.
